(19) United States
(12) Patent Application Publication
(10) Pub. No.: US 2008/0288380 A1
(43) Pub. Date: Nov. 20, 2008

(54) Method and System for Providing Streamed Game Software on Portable Terminal

(75) Inventors: Ki-Hyuk Nam, Daejeon (KR); Jin-Ryong Kim, Daejeon (KR); Kwang-Hyun Shim, Daejeon (KR); Won-Young Kim, Daejeon (KR); Wan Choi, Daejeon (KR); Myung-Joon Kim, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Instit, Daejeon (KR)

(21) Appl. No.: 12/096,535

(22) PCT Filed: Dec. 5, 2006
(86) PCT No.: PCT/KR06/05192

§ 371 Date: Jun. 6, 2008

(30) Foreign Application Priority Data
Dec. 8, 2005 (KR) 10-2005-0119897
Aug. 4, 2006 (KR) 10-2006-0073879

(51) Int. Cl. G06Q 30/00; G06F 15/16

(52) U.S. Cl. 705/34; 709/231

(57) ABSTRACT

A system and method for providing streaming game software for a portable terminal are provided. The system includes a software producer, a service provider, a portable terminal, and a billing device. The software producer produces streaming software, and the service provider provides the software in a streaming mode. The portable terminal creates virtual computing resources by virtualizing and amplifying real computing resources for executing software and executes streaming software provided from the service provider based on the amplified virtual computing resource. The billing devices collects billing information, and calculates a cost according to a billing policy set based on the collected billing information.

### TECHNICAL FIELD

The present invention relates to a method for providing game software for a portable terminal, and more particularly, to a method and an apparatus for providing game software for a portable terminal in a streaming mode, which can overcome capacity limitation of the game software caused by limited computing resources of the portable terminal, provide more realistic game software instantly, and operate billing system corresponding to the provision.

### BACKGROUND ART

Generally, a portable terminal is coming to a market with game software installed on it, which can be executed through computing resource possessed by the portable terminal at the time of producing it. As the wired/wireless Internet service prevails, and terminal equipments such as portable game devices, portable terminals, or cellular phones have come into wide use, portable terminals has become to provide various services.

Game contents used in game consoles, for example, the Play Station Portable (PSP), among various softwares for portable terminals have attracted public attention explosively. Particularly, in three dimensional game services, for example, GxG or GPang, provided by telecommunications providers, software for a terminal can be executed through a network. Also, this kind of game service is advantageous in that it is easy to execute game contents by downloading them through a network, instead of installing directly the game contents through an additional storage medium.

To execute a game provided through a network, users should pay a charge for using the game contents and communications to a service provider, and wait for completing download of entire file constituting the game software. It might cause the users to feel inconvenience.

Also, a method of providing according to the related art has a problem in that the capacity and quality of a game are limited by the specification of the computing resource of a portable terminal. Moreover, the method has another problem in that a user should pay a charge for the entire game contents even when the user uses the game for a certain time or uses a part of the game.

As mentioned above, techniques related to the manufacture of game software and the provision of services for a portable terminal have not emerged from the existing method, for example, a method of directly installing game software through a storage medium or a method of downloading game software through a network, while the function and service scheme of a portable terminal have been developing day by day.

Meanwhile, to overcome the afore-mentioned problems, techniques such as on-demand-software-service or software-on-demand (SoD) are used in a typical computer network environment. Like the existing multimedia service such as video-on-demand (VoD) or music-on-demand (MoD), they are a technique that executes software at a user computer through a network in a streaming mode. However, the SoD technique has not been proposed for the manufacture and provision of game software considering the limited computing resource of a portable terminal yet.

### DISCLOSURE OF INVENTION

### Technical Problem

The present invention has been made to solve the foregoing problems of the prior art and it is therefore an object of certain embodiments of the present invention to provide a method and system for providing large game software that can be smoothly executed in a portable terminal without having difficulties due to the limitation of computing resources of the portable terminal.

Another object of the present invention is to provide a system and method for providing game software for a portable terminal for producing game software that can be provided in a transmission mode that is not limited by the limitation of computing resources of the portable terminal and for accurately and rapidly performing a billing operation according to the providing of the produced game contents.

### Technical Solution

In order to achieve the above objects, the present invention provides a portable terminal including: a computing resource virtualization device for creating virtual computing resources by virtually amplifying real computing resources for executing program; and a streaming software processing device for executing predetermined streaming software, which is provided as streaming through a network, in a streaming mode based on the amplified virtual computing resources.

The computing resource virtualization device may include: an resource virtualization unit for creating the virtual computing resources by virtualizing the real computing resources; a streaming cooperation unit for providing an interface to cooperate with the streaming software processing device for executing streaming software based on the virtual computing resource at the streaming software processing device; a platform cooperation unit for providing an interface to cooperate with a platform required for driving a system for executing the software; and a billing cooperation unit for providing an interface to cooperated with a billing device that processes a predetermine billing operation set according to the providing of the streaming of the software.

The resource virtualization unit may include: a memory virtualization unit for creating virtual memory information by amplifying memory information among the real computing resource; and a display virtualization unit for creating virtual resolution information by amplifying resolution information among the real computing resource.

The computing resource may include main memory information, axially memory information, and resolution information.

The streaming software processing device may include: a streaming processing unit for detecting code and data from the streaming software, and executing the software according to restored and process information corresponding to the detected code and data; a code information processing unit for restoring and processing the detected code information from the streaming software and providing the restored and processed code to the streaming software unit; and a data information processing unit for restoring and processing the detected data information from the streaming software and providing the restored and processed data to the streaming software unit.

The code information processing unit may search additional required code information of the software executed through the streaming processing unit, request the searched code information to an external service provider, restore the code information provided from the service provider, and provide the restored code information to the streaming processing unit.

The data information processing unit may search additional required data information of the software executed through the streaming processing unit, request the searched data information to an external service provider, restore the data information provided from the service provider, and provide the restored data information to the streaming processing unit.

The streaming processing unit may include: a program executing processing unit for executing the streaming software based on the virtual computing resource; a computing resource virtualization device cooperating unit for providing an interface to cooperate with the computing resource virtualization device for receiving the virtual computing resources; a platform cooperating unit for providing an interface to cooperate with a platform required for driving a system for executing the software; and a billing device cooperating unit for providing an interface to cooperated with a billing device that performs a billing operation set according to the providing of the stream software.

The data included in the software includes at least one of graphic data, software constitution data, and computing resource information data.

According to another aspect of the present invention, there is provided an apparatus for producing streaming software for a portable terminal including: software producing basic information for storing basic information required for producing streaming software for a portable terminal; and a software producing unit for producing the streaming software for a portable terminal based on the software producing basic information.

The software producing basic information may include software progression and constitution information, distribution and billing information, streaming processing information, computing resource use information, and software code information.

The software producing unit may include: a resource virtualization information processing unit for setting virtualization information of the computing resources required for executing the software with reference to the computing resource use information; a streaming information processing unit for setting streaming providing information of the software with reference to the streaming processing information; a billing information processing unit for setting billing information according to the providing of the streaming software with reference to the distribution and the billing information; and a compiler/packaging unit for producing the streaming software for a portable terminal through the software source code information of the software having the set virtual computing resource information, the set streaming providing information, and the set billing information.

According to further another aspect of the present invention, there is provided a billing apparatus for streaming software for a portable terminal including: a billing information collecting unit for collecting billing information when streaming software for a portable terminal is provided to a portable terminal in a streaming mode; and a cost billing unit for billing a cost calculated according to a billing policy based on the collected billing information.

The cost billing unit may provide the calculated cost information to a service provider that provide the streaming software for a portable terminal.

The billing information may include at least one of software progression state information, packet transmitting amount information, software constitution information, software use time information and user information.

According to still another aspect of the present invention, there is provided a method for providing streaming software for a portable terminal, including the steps of: a) creating virtual computing resources by virtualizing and amplifying real computing resources of a portable terminal; b) transmitting request information of providing streaming of software to a service provider that provide the software in response to input of the request of providing streaming of software contents; c) receiving the streaming software from the service provider; d) executing the received streaming software based on the virtual computing resource; and e) collecting billing information according to the execution of the streaming software, calculating a cost thereof, and providing the calculated cost information to the service provider.

The method may further include the steps of: f) searching code and data of software required additionally while executing the streaming software; g) transmitting request information of the searched code and data of additionally required software to the service provider; and h) receiving the request code and data from the service provider and continuously executing the streaming software based on the received code and data.

According to yet another aspect of the present invention, there is provided a software providing system including: a software producer for producing streaming software with reference to software producing basic information required for producing software; a serviced provider for providing the software in a streaming mode according to a request of providing the produced software; a portable terminal for creating virtual computing resources by virtualizing and amplifying real computing resources disposed for executing the program, and executing streaming software provided from the service provider based on the amplified virtual computing resource; and a billing apparatus for collecting billing information according to providing of the software which is provided in a streaming mode to the portable terminal, and calculating a cost according to a billing policy set based on the collected billing information.

According to the present invention, the computing resource of the portable terminal is virtualized, and the game software is installed and executed in a streaming mode. Accordingly, the cost of using the software is billed based on the real provided information. Therefore, the user of the portable terminal can instantly execute the game software without waiting the entire game software to be downloaded, and can pay the cost of real provided information.

### ADVANTAGEOUS EFFECTS

As described above, in the method for providing streaming game software for a portable terminal according to the present invention, the computing resource of a portable terminal are virtualized, the game software is installed and executed in the streaming mode, and the cost of using the game software is calculated according to really provided information. Therefore, a user is allowed to play the game software instantly without waiting entire software to be downloaded, and to pay the cost of using the game software, which is billed according to the real provided information.

Also, in the method for providing streaming game software for a portable terminal according to the present invention, the real computing resource is virtualized to amplified virtual computing resources in order to provide game software. A game software producer can compose game software without having difficulties of the limited computing resources. Therefore, the service provider can provide more realistic game using large amount of computing resources to a portable terminal.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a block diagram illustrating a system for providing streaming game software for a portable terminal according to an exemplary embodiment of the present invention;

FIG. 2 is a block diagram illustrating the computing resource virtualization device of a portable terminal for virtualizing computing resources for executing game software in FIG. 1 and cooperating the real computing resource information and the virtual computing resource information according to an exemplary embodiment of the present invention;

FIG. 3 is a block diagram illustrating the streaming game software processing unit of a portable terminal for receiving game software in a streaming mode and executing the received game software based on virtual computing resources according to an embodiment of the present invention;

FIG. 4 is a block diagram illustrating a producer of producing game software to be provided in a steaming mode in consideration of virtual computing resource information of a portable terminal of FIG. 1 according to an embodiment of the present invention;

FIG. 5 is a block diagram illustrating a billing device of streaming software that produced to be provided in a streaming mode in consideration of virtual computing resources of a portable terminal of FIG. 1 according to an embodiment of the present invention; and

FIG. 6 is a flowchart illustrating a method for providing streaming game software for a portable terminal according to an embodiment of the present invention.

### BEST MODE FOR CARRYING OUT THE INVENTION

Hereinafter, preferred embodiments of the present invention will be described in detail with reference to the attached drawings.

The present invention provides a method and an apparatus for providing streaming game software for a portable terminal to overcome the capacity limitation of game software caused by limited computing resources of a portable terminal. The present invention also provide a method and an apparatus for providing streaming game software for accurately billing according to real-provided services by instantly providing streaming game software without waiting the entire software to be downloaded. The present invention also provides a method and an apparatus for providing game software for a portable terminal, which allows a producer to produce software without being limited by the limitation of the computing resources of a portable terminal.

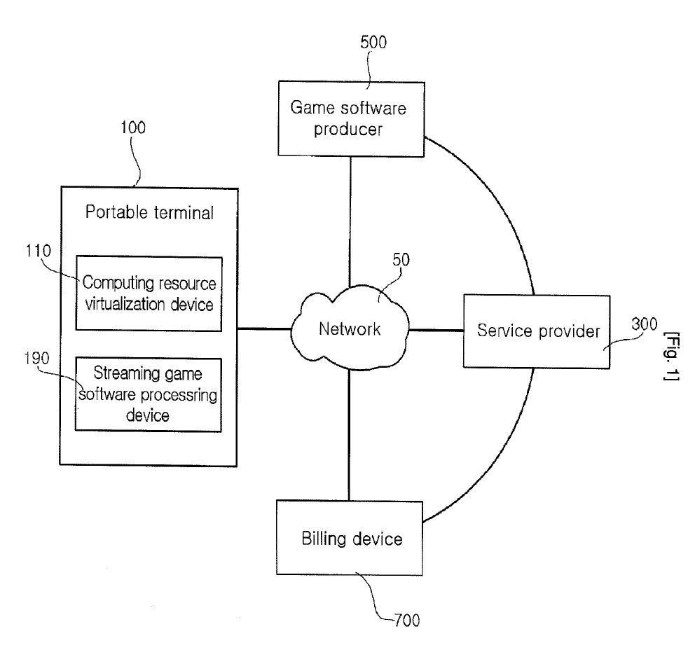

FIG. 1 is a block diagram illustrating a system for providing streaming game software for a portable terminal according to an exemplary embodiment of the present invention.

As shown in FIG. 1, the system for providing game software according to the present embodiment includes a portable terminal 100, a service provider 300, a game software producer 500, and a billing device 700.

The portable terminal 100 creates virtual computing resource by performing virtualization to its computing resources, and downloads game software in a streaming mode according to the generated virtual computing resource to execute a game. For this operation, the portable terminal 100 includes a computing resource virtualization device 110 and a streaming game software operating device 190.

The computing resource virtualization device 110 performs virtualization to transform real computing resource into virtual computing resource that can execute mass game software provided in a streaming mode. To receive and execute the corresponding game software in the streaming mode, the streaming game software operating device 190 requests data and code information of the game software to the service provider 300 and processes the data and code information provided from the service provider 300 to execute the game.

The service provider 300 provides the corresponding game software to the portable terminal 100 through a network 50 in the streaming mode in response to the request of the portable terminal 100. Preferably, the service provider 300 provides the specific data and code information of the game software requested from the portable terminal 100 to the portable terminal through the network 50 in the streaming mode.

The game software producer 500 generates game software that can be provided in the streaming mode based on the computing resource virtualization of the portable terminal and the platform of the portable terminal of which computing resource was virtualized, and provides the game software to the service provider 300. The billing device 700 collects billing information that is set according to the use of the game software provided from the service provider 300 to the portable terminal 100 in the streaming mode, and provides the information to the service provider 300. Here, the billing device 700 may also be included in the service provider 300.

The streaming mode applied into the exemplary embodiments of the present invention is a technique that divides entire data into a plurality of portions and transmits and processes only necessary portions in response to requests instead of transmitting entire data used for a communication apparatus and processing the data at once. A software streaming technique allows users to execute corresponding software by receiving necessary portions in a communication apparatus in an On-Demand mode after producing and storing the software in a predetermined software package format for the software stream technique.

The portable terminal 100 accesses the service provider that stores game software capable of being provided in a streaming mode, downloads predetermined game software from the service provider in the streaming mode, executes the downloaded game software, and deletes the streams thereof after terminating the game software. As described above, the portable terminal 100 downloads and uses only necessary portions of corresponding gate software when it is required without directly installing entire game software into the portable terminal 100. Therefore, it can reduce the economic burden of purchasing entire game software and the computing resource burden of installing the gate software, thereby effectively managing the game software.

The game software produced by the gate software producer 500 is transmitted from the service provider 300 to the portable terminal 100 through the network 50. While transmitting the game software to the portable terminal 100 in streaming mode, the billing device 700 collects the information about the use and the billing of the gate software from the portable terminal 100 and transfers the collected information to the service provider 300. The game software producer 500 produces game software to be provided in a streaming mode, and to be billed according to the user of the game software provided in the streaming mode.

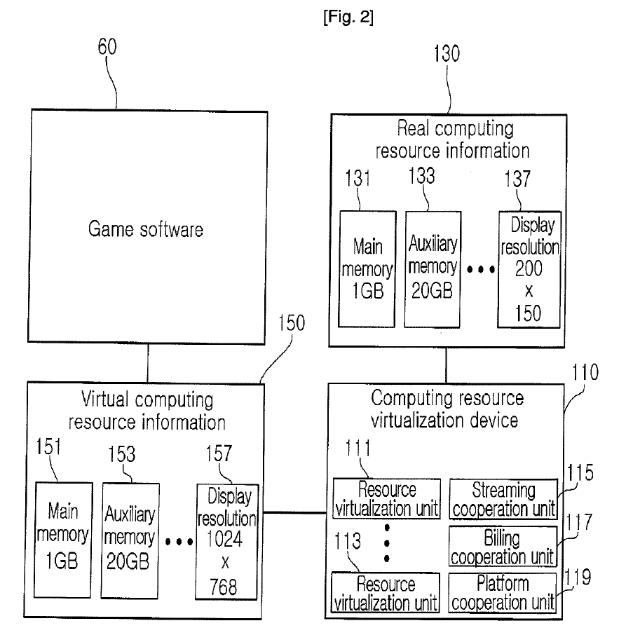

FIG. 2 is a block diagram illustrating the computing resource virtualization device of a portable terminal in FIG. 1 according to an exemplary embodiment of the present invention. The computing resource virtualization device virtualizes computing resource for executing game software and connects the virtualized computing resource information and real computing resource.

As shown in FIG. 2, the computing resource virtualization device 110 of a portable terminal transforms real computing resource information 130 such as a main memory 131, an auxiliary memory 133, and a display resolution 137 to the corresponding executable virtual computing resource information 150 of mass game software, such as a main memory 151, an auxiliary memory 153, and a display resolution 157. Accordingly, the game software 60 that is made by the software producer 500 and then provided through the service provider 300 is executed by recognizing the virtual computing resource information 150 as the real computing resource information of the portable terminal 100.

The computing resource virtualization device 110 includes a resource virtualization unit 111 and 113, a streaming cooperation unit 115, a billing cooperation unit 117, and a platform cooperation unit 119.

The resource virtualization unit 111 and 113 virtualizes each of the real computing resource information 130 such as memories 131 and 133, and a display resolution 137 to virtual computer resource information 150. In the present embodiment, the memory virtualization unit 111 virtualizes the real 16 MB main memory 131 to a virtual 1 GB main memory 151. Also, the memory virtualization unit 111 virtualizes the real 256 MB auxiliary memory 133 to a virtual 20 GB auxiliary memory.

The streaming cooperation unit 115 provides an interface to cooperate with a streaming processing unit 300 of the service provider 300 for executing game software in the portable terminal 100 through streaming from the service provider 300.

The billing cooperation unit 117 provides an interface to cooperate with the billing device 700 for billing a user according to the user of game software provided in a streaming mode.

The platform cooperation unit 119 provides an interface to cooperate with a platform of a portable terminal 100 for performing game software provided in a streaming mode.

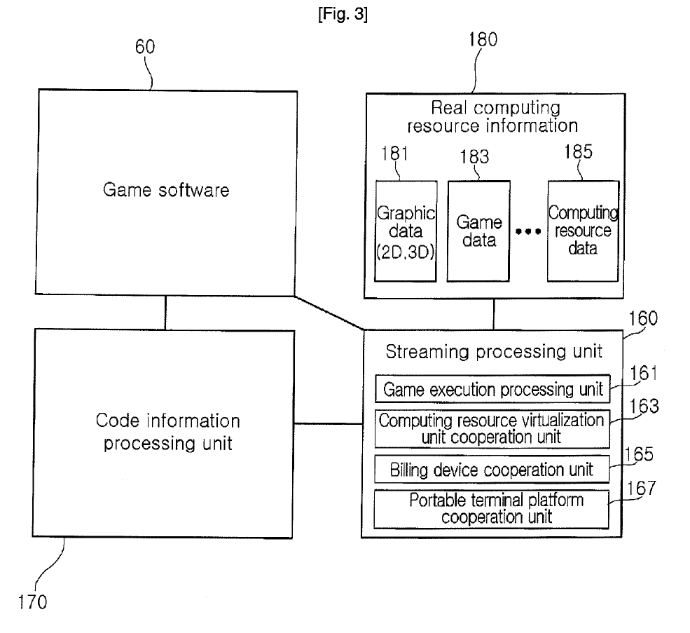

FIG. 3 is a block diagram illustrating a streaming game software processing unit of a portable terminal that receives game software in a streaming mode and executes the received game software based on virtual computing resources according to an embodiment of the present invention.

As shown, the streaming game software processing unit 190 includes a streaming processing unit 160, a code information processing unit 170, and a data information processing unit 180.

The streaming processing unit 160 receives corresponding data and code of game software 60 from a data information processing unit 310 and a code information processing unit 350 occasionally when the portable terminal 100 requires them in the streaming mode although all data and code of the game software 60 are not transmitted to the portable terminal 100. Then, the streaming processing unit 160 executes the received data and code of the gate software 60.

The streaming processing unit 160 includes a game execution processing unit 161, a virtualization unit cooperation unit 163, a billing device cooperation unit 165, and a portable terminal platform cooperation unit 167.

The game execution processing unit 161 executes the game software according to the streaming mode using the virtual computing resource information 150 by cooperating with the platform of the portable terminal 100. In more detail, the game execution processing unit 161 executes the game by detecting and processing information related to the execution of the game from the game software 60 transmitted from the service provider 300, such as a stage map, a user level, an item, and software binary. The game execution processing unit 161 analyzes the information included in the game software 60 and provides software binary codes such as instructions or codes for executing the software to the code information processing unit 170. Also, the game execution processing unit 161 provides information related to data for executing the game software, such as memories, files, maps and graphic data, to the data information processing unit 180 to process them. Also, the game execution processing unit 161 manages information about stream-able game software together with a predetermined portion of game software currently stored in the portable terminal 100, and reflects the management result to the execution of the game software.

The computing resource virtualization device cooperation unit 163 provides an interface to the computing resource virtualization device 110 of FIG. 2. Also, the computing resource virtualization device cooperation unit 163 transfers the real computing resource information 130 of the portable terminal to the computing resource virtualization device 110 and receives the virtualized computing resource information 150. Then, the received virtual computing resource information 150 is transmitted to the game execution processing unit 161.

The billing device cooperation unit 165 provides an interface to the billing device 700 of FIG. 1, and transfers the billing related information to the billing device in response to the request thereof, where the billing related information is information about the distribution and execution of the game software provided in the streaming mode.

The portable terminal platform cooperation unit 167 provides an interface to a platform of the portable terminal 100. Accordingly, the game software is executed by being cooperated with the platform of the portable terminal 100 after processing operations required for processing the streaming of the portable terminal 100.

The code information processing unit 170 decodes the information related to software binary code included in the game software according to the request of the game execution processing unit 161. The code information processing unit 170 searches code data required according to the execution of the streaming mode of the game software, transforms the requested information of the searched code data to a recognizable format, and requests it to the service provider 300.

The data information processing unit 180 decodes data required for executing the game software among data included in the game software according to the request of the game execution processing unit 161. That is, the data information processing unit 180 provides graphic data 181, game data 182, and computing resource data 185 of the portable terminal to the game execution processing unit 161 for decoding them to execute the game software. Also, the data information processing unit 180 searches data of game software for executing the game software additionally. Then, the data information processing unit 180 requests the request information of the searched data to the service provider 300, and receives the request information from the service provider 300.

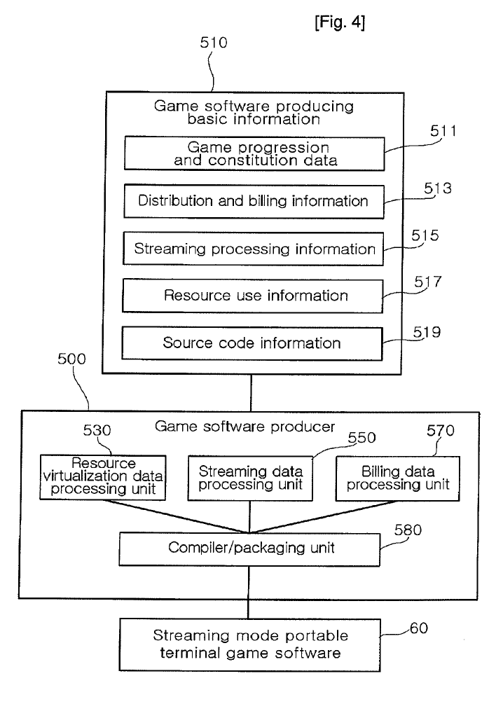

FIG. 4 is a block diagram illustrating the game software producer 500 shown in FIG. 1 according to an embodiment of the present invention.

Referring to FIG. 4, the game software producer 500 includes game software producing basic information 510 which is fundamental information for producing game software designed and set by a developer.

Herein, the game software producing basic information 510 includes game progression and constitution data 511, distribution and billing data 513, streaming processing data 515, resource usage data 517 and source code data 519.

The game progression and constitution data 511 is information including a scenario of a game, game flow, a stage structure, a main menu, an opening and ending credit, items, characters, animations and graphics. The distribution and billing data 513 is information including related to a distribution and billing policy of a game software producer and a service provider.

The streaming processing data 515 is information related to a streaming state for executing game software and operation thereof. The resource usage data 517 is information related to computing resources for executing the game software, such as memory capacity and resolution.

The source code data 519 includes code data composed by a predetermined programming language such as C or Java for executing the game software in the portable terminal 100.

The game software producing basic information 510 can be composed in a file, or composed in separated files according to its type. Also, they can be referred to each others and semantically connected each other according to the overall progression and configuration of the game software. The game software producing basic information can be used for producing game software of the game software producer 500 according to an embodiment of the present invention.

The game software producer 500 includes a resource virtualization data processing unit 530, a streaming data processing unit 550, a billing data processing unit 570, and a compiler/packaging unit 580.

The resource virtualization data processing unit 530 sets resource virtualization option data for executing game software through streaming based on a processing power of each of resources through analyzing the resource use information 517.

The streaming data processing unit 550 sets code information including game software to be produced based on the streaming processing information 515, data information and streaming transmit option information.

The billing data processing unit 570 sets billing operations according to providing of contents of game software, and according to the use of the provided contents based on the distribution and billing data 513.

The compiler/packaging unit 580 composes game software for a portable terminal by compiling and packaging information required at the platform of the portable terminal 100 based on the source code data 519 for the game software processed through the resource virtualization option setting, the streaming option setting, and the billing setting.

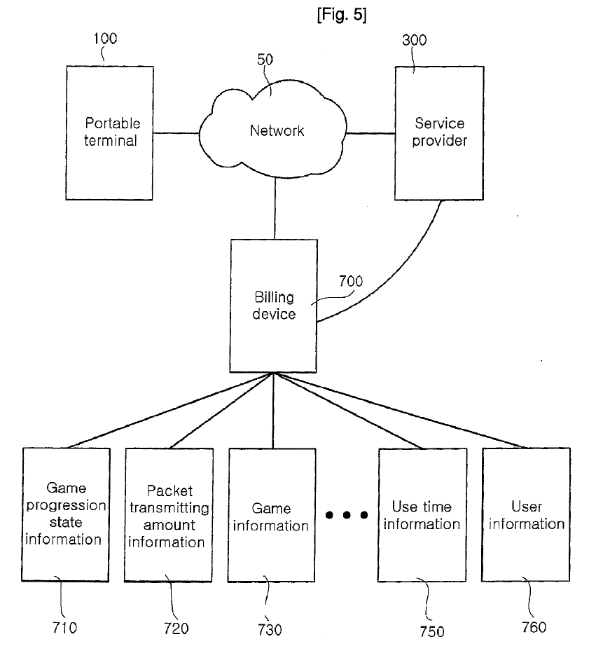

FIG. 5 is a block diagram illustrating a billing device 700 shown in FIG. 1 according to an embodiment of the present invention.

As shown in FIG. 5, the billing device 700 collects billing information according to the execution of game software provided through streaming when the game software is executed through the streaming provided from the service provider 300 to the portable terminal 100, and provides the collected information to the service provider 300.

The billing related information includes game progression state information 710, packet (code and data) transmitting amount information 720, game information 730 such as a title, a map, or a version, use time information 750, and user information 760.

Accordingly, the billing device 700 calculates a cost for providing a streaming service of game software according to the collected billing related information and provides the calculated cost to the service provider 300. Therefore, it is possible to logically bill the portable terminal 100 according to the use of the game software.

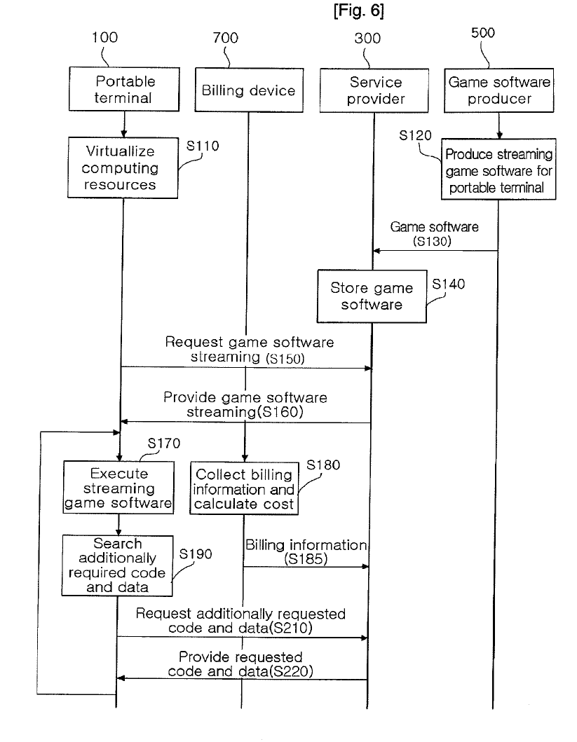

FIG. 6 is a flowchart illustrating a method for providing streaming game software for a portable terminal according to an embodiment of the present invention.

Referring to FIG. 6, at step S110, a portable terminal 100 virtualizes real computing resources to virtual resources for executing game software in a predetermined capacity.

A game software producer 500 produces streaming game software for a portable terminal in consideration of portable terminal computing resource virtualization, streaming and billing settings at step S120. The game software producer 500 provides the produced game software to a service provider 300 at step S130. The service provider 300 stores the game software from the game software produce 500 at step S140.

When a portable terminal 100 receives an instruction for executing the streaming of game contents through communication, the portable terminal 100 transmits the streaming providing request information of game contents to the service provider 300 at step S150. At step S160, the service provider 300 provides the streaming of game software in response to the streaming providing request information from the portable terminal 100. It is preferable that the service provider 300 provides the streaming of predetermine code and data of requested game software only to the portable terminal 100.

Accordingly, at step S170, the portable terminal 100 executes the game software according to the streaming mode, which is provided from the service provider 300.

The billing device 700 collects billing information set according to the providing of game software to the portable terminal 100 through the streaming by the service provider 300 and another billing information according to the execution of game software provided through streaming, and calculates the cost thereof at step S180. The billing device 700 provides the calculated cost to the service provider 300 at step S185.

The portable terminal 100 searches additionally required codes and data of game software while executing the game software in the streaming mode at step S190. Accordingly, if the additionally required codes and data are seared, the portable terminal 100 transmits the request information of the additionally required codes and data to the service provider 300 at step S210.

When the service provider 300 received the request information of the additionally required codes and data, the service provider 300 transmits the requested code and data of game software to the portable terminal 100 at step S220.

Afterward, the steps S170 to S220 are performed among the portable terminal 100, the billing device 700 and the service provider 300.

Although the preferred embodiments of the present invention have been disclosed for illustrative purpose, those skilled in the art will appreciate that various modifications, additions and substitutions can be made without departing from the scope and spirit of the invention as defined in the accompanying claims.

1. A portable terminal, comprising:
a computing resource virtualization device for creating virtual computing resources by virtually amplifying real computing resources for executing program; and
a streaming software processing device for executing predetermined streaming software, which is provided as streaming through a network, in a streaming mode based on the amplified virtual computing resources.

2. The portable terminal according to claim 1, wherein the computing resource virtualization device includes:
an resource virtualization unit for creating the virtual computing resources by virtualizing the real computing resources;
a streaming cooperation unit for providing an interface to cooperate with the streaming software processing device for executing streaming software based on the virtual computing resource at the streaming software processing device; and
a platform cooperation unit for providing an interface to cooperate with a platform required for driving a system for executing the software.

3. The portable terminal according to claim 2, wherein the computing resource virtualization device further includes a billing cooperation unit for providing an interface to cooperated with a billing device that processes a predetermine billing operation set according to the providing of the streaming of the software.

4. The portable terminal according to claim 2, wherein the resource virtualization unit includes:
a memory virtualization unit for creating virtual memory information by amplifying memory information among the real computing resource; and
a display virtualization unit for creating virtual resolution information by amplifying resolution information among the real computing resource.

5. The portable terminal according to claim 1, wherein the computing resource is at least one of main memory information, axially memory information, and resolution information.

6. The portable terminal according to claim 1, wherein the streaming software processing device includes:
a streaming processing unit for detecting code and data from the streaming software, and executing the software according to restored and process information corresponding to the detected code and data;
a code information processing unit for restoring and processing the detected code information from the streaming software and providing the restored and processed code to the streaming software unit; and
a data information processing unit for restoring and processing the detected data information from the streaming software and providing the restored and processed data to the streaming software unit.

7. The portable terminal according to claim 6, wherein the code information processing unit searches additional required code information of the software executed through the streaming processing unit, requesting the searched code information to an external service provider, restoring the code information provided from the service provider, and providing the restored code information to the streaming processing unit.

8. The portable terminal according to claim 6, wherein the data information processing unit searches additional required data information of the software executed through the streaming processing unit, requesting the searched data information to an external service provider, restoring the data information provided from the service provider, and providing the restored data information to the streaming processing unit.

9. The portable terminal according to claim 6, wherein the streaming processing unit include:
a program executing processing unit for executing the streaming software based on the virtual computing resource;
a computing resource virtualization device cooperating unit for providing an interface to cooperate with the computing resource virtualization device for receiving the virtual computing resources; and
a platform cooperating unit for providing an interface to cooperate with a platform required for driving a system for executing the software.

10. The portable terminal according to claim 9, wherein the streaming processing unit further includes a billing device cooperating unit for providing an interface to cooperated with a billing device that performs a billing operation set according to the providing of the stream software.

11. The portable terminal according to claim 6, wherein the data included in the software includes at least one of graphic data, software constitution data, and computing resource information data.

12. The portable terminal according to claim 1, wherein the software is game software.

13. An apparatus for producing streaming software for a portable terminal comprising:
software producing basic information for storing basic information required for producing streaming software for a portable terminal; and
a software producing unit for producing the streaming software for a portable terminal based on the software producing basic information.

14. The apparatus according to claim 13, wherein the software producing basic information includes at least one of software progression and constitution information, distribution and billing information, streaming processing information, computing resource use information, and software code information.

15. The apparatus according to claim 14, wherein the software producing unit includes:
a resource virtualization information processing unit for setting virtualization information of the computing resources required for executing the software with reference to the computing resource use information;
a streaming information processing unit for setting streaming providing information of the software with reference to the streaming processing information;
a billing information processing unit for setting billing information according to the providing of the streaming software with reference to the distribution and the billing information; and
a compiler/packaging unit for producing the streaming software for a portable terminal through the software source code information of the software having the set virtual computing resource information, the set streaming providing information, and the set billing information.

16. The apparatus according to claim 13, wherein the software is game software.

17. A billing apparatus for streaming software for a portable terminal comprising:
a billing information collecting unit for collecting billing information when streaming software for a portable terminal is provided to a portable terminal in a streaming mode; and
a cost billing unit for billing a cost calculated according to a billing policy based on the collected billing information.

18. The billing apparatus according to claim 17, wherein the cost billing unit provides the calculated cost information to a service provider that provide the streaming software for a portable terminal.

19. The billing apparatus according to claim 17, wherein the billing information includes at least one of software progression state information, packet transmitting amount information, software constitution information, software use time information and user information.

20. The billing apparatus according to claim 17, wherein the software is game software.

21. A method for providing streaming software for a portable terminal, comprising the steps of:
a) creating virtual computing resources by virtualizing and amplifying real computing resources of a portable terminal;
b) transmitting request information of providing streaming of software to a service provider that provide the software in response to input of the request of providing streaming of software contents;
c) receiving the streaming software from the service provider;
d) executing the received streaming software based on the virtual computing resource; and
e) collecting billing information according to the execution of the streaming software, calculating a cost thereof, and providing the calculated cost information to the service provider.

22. The method according to claim 21, further comprising the steps of:
f) searching code and data of software required additionally while executing the streaming software;
g) transmitting request information of the searched code and data of additionally required software to the service provider; and
h) receiving the request code and data from the service provider and continuously executing the streaming software based on the received code and data.

23. The method according to claim 21, wherein the software is game software.

24. A software providing system comprising:
a software producer for producing streaming software with reference to software producing basic information required for producing software;
a service provider for providing the software in a streaming mode according to a request of providing the produced software; and
a portable terminal for creating virtual computing resources by virtualizing and amplifying real computing resources disposed for executing the program, and executing streaming software provided from the service provider based on the amplified virtual computing resource.

25. The software providing system according to claim 24, further comprising a billing apparatus for collecting billing information according to providing of the software which is provided in a streaming mode to the portable terminal, and calculating a cost according to a billing policy set based on the collected billing information.
